(19) United States
(12) Patent Application Publication
(10) Pub. No.: US 2010/0293004 A1
(43) Pub. Date: Nov. 18, 2010

(54) PAYER ESTIMATION AND IDENTIFICATION METHODS AND APPARATUS

(76) Inventors: Vernon Jack Nye, Watertown, MA (US); Joseph Hendrickson, Belmont, MA (US); Yuran Lu, Cambridge, MA (US); Christopher Bassolino, Watertown, MA (US)

Correspondence Address: WOLF GREENFIELD & SACKS, P.C., 600 ATLANTIC AVENUE, BOSTON, MA, 02210-2206, US

(21) Appl. No.: 12/780,375

(22) Filed: May 14, 2010

Related U.S. Application Data
(60) Provisional application No. 61/178,879, filed on May 15, 2009.

(51) Int. Cl. G06Q 50/00; G06Q 10/00; G06Q 40/00

(52) U.S. Cl. 705/2

(57) ABSTRACT

Methods and apparatus for generating a list of likely payers for a medical practice based on historical data stored on a practice management system and practice-specific information. Information about the claim volumes for payers during a predetermined time range in a geographical region are used to estimate a subset of likely payer that a medical practice may like to enroll with. User-selectable billing frequency indicators for each of the payers identified in the subset facilitate claim billing management and enrollment strategies for billing personnel at the medical practice resulting in fewer disruptions in claim processing and cash flow as the medical practice is implemented on the practice management system.

### RELATED APPLICATIONS

This Application claims priority under 35 U.S.C. §119(e) to U.S. Provisional Application Ser. No. 61/178,879, entitled “PAYER ESTIMATION AND IDENTIFICATION METHODS AND APPARATUS” filed on May 15, 2009, which is herein incorporated by reference in its entirety.

### TECHNICAL FIELD

The present invention relates generally to the implementation of a medical practice's billing process on a practice management system, and more specifically to identifying likely payers for a medical practice based on historical data and/or practice-specific information.

### BACKGROUND

In modern healthcare systems, individuals typically have access to a large number of healthcare payers which vary in their payment coverage for services rendered by medical practices. For example, some individuals may choose Fee-for-Service health insurance plans, whereas other individuals may choose to be covered by Health Maintenance Organizations (HMOs), Point-of-Service plans (POS), or Preferred Provider Organizations (PPOs). The complexities introduced by the large number of healthcare payer options available to patients of a medical practice may result in underpayment for services provided by the medical practice in the absence of an administrative system that can effectively resolve these complexities.

Ensuring that medical practices are properly reimbursed for the services that they provide to patients is an important consideration for the medical practices. Reimbursement is typically initiated by sending one or more claims describing a patient's medical services to a patient's healthcare payer. In turn, the payer remits payment to the medical practice or denies the claim based on the patient's healthcare coverage.

To assist in the processing of claims, some medical practices may contract with a third party which provides a practice management system for facilitating and tracking the status of claims submitted to the multitude of healthcare payers chosen by patients of the medical practice. For example, the practice management system may be a network-based system that enables billing personnel at a medical practice to view the status of claims submitted to a patient's healthcare payer to determine if and when remittance for the claims is received. If remittance is not received, the billing personnel may investigate the situation further to determine a reason for the denial of the claims so that additional steps may be taken to ensure that the claims are paid.

### SUMMARY

When a medical practice's billing process is implemented on a practice management system, the practice is typically enrolled with multiple healthcare payers to ensure a smooth flow of claim transactions. Applicants have recognized and appreciated that at the time of enrollment, many practices are unaware of the insurance mix of the practice's patient base. As a result, a practice may choose to enroll healthcare payers on an as-needed basis. That is, enrollment with a new healthcare payer may occur each time a patient is treated at the practice who carries health insurance administered by an healthcare payer which has not been previously enrolled. This approach, however, is inefficient and may result in a cash flow interruption for the practice while the new healthcare payer is being enrolled. An alternative approach is for the practice to enroll all conceivable healthcare payers, thereby eliminating the risk of cash flow interruption. However, this approach is also inefficient, because it is likely that not all of the potential payers which are identified, must necessarily be enrolled based on the practice's patient base, leading to a significant amount of time and resources invested in unnecessary contact with some of the healthcare payers.

Applicants have recognized and appreciated that the process of identifying and enrolling a medical practice with healthcare payers when implementing the medical practice on a practice management system may be improved by providing a user (e.g., billing personnel) at the medical practice with an interactive enrollment interface which enables the user to narrow down the list of potential healthcare payers prior to enrollment.

Applicants have also recognized and appreciated that some medical practices may be concerned about cash flow reductions during the time when the medical practice becomes implemented on a practice management system. Accordingly, in some embodiments, a list of healthcare payers and historical data about the healthcare payers, which is stored on the practice management system, is used to estimate an amount of a medical practice's uninterrupted cash flow at the date when the medical practice is implemented on the practice management system.

Some embodiments are directed to a method of identifying a subset of payers based at least in part on historical data, wherein the historical data comprises information about claim volumes for a plurality of payers within a geographical location.

Some embodiments are directed to a computer-readable medium, encoded with a series of instructions, that when executed by a computer, perform a method of identifying a subset of payers based at least in part on historical data, wherein the historical data comprises information about claim volumes for a plurality of payers within a geographical location.

Some embodiments are directed to a computer system comprising at least one client computer and at least one host computer coupled to the at least one host computer, the at least one host computer having at least one program stored thereon, that when executed, performs a method of identifying a subset of payers based at least in part on historical data, wherein the historical data comprises information about claim volumes for a plurality of payers within a geographical location.

Some embodiments are directed to a method of calculating a claim volume statistic for a payer on a payer list, wherein the payer list is generated based at least in part on historical data, wherein the historical data comprises information about claim volumes for a plurality of payers within a geographical location.

It should be appreciated that all combinations of the foregoing concepts and additional concepts discussed in greater detail below (provided that such concepts are not mutually inconsistent) are contemplated as being part of the inventive subject matter disclosed herein.

### BRIEF DESCRIPTION OF THE DRAWINGS

The accompanying drawings are not intended to be drawn to scale. In the drawings, each identical or nearly identical component that is illustrated in various figures is represented by a like reference character. For purposes of clarity, not every component may be labeled in every drawing. In the drawings:

FIG. 1 is a flow chart of a method for generating a list of payers in accordance with some embodiments of the invention;

FIG. 2 is a display of a portion of a user interface for displaying a preliminary payer list in accordance with some embodiments of the invention;

FIG. 3 is a display of a portion of a user interface for displaying a summary payer list in accordance with some embodiments of the invention;

FIGS. 4A and 4B are displays of portions of a user interface for entering search criteria to add a payer in accordance with some embodiments of the invention;

FIGS. 5A, 5B, and 5C are displays of portions of a user interface for adding a new insurance package in accordance with some embodiments of the invention;

FIG. 6 is a display of a portion of a user interface for manually entering payer information in accordance with some embodiments of the invention;

FIGS. 7A and 7B are displays of a portion of an interface for showing enrollment information for a medical practice; and

FIG. 8 is a schematic of a network environment in which some embodiments of the invention may be employed.

### DETAILED DESCRIPTION

The present disclosure generally relates to inventive methods and apparatus for determining a list of payers to which a given medical practice is likely to bill, and more specifically to generating the list of payers based in part on historical data and/or practice-specific information. Central to a medical practice's billing process is information about particular payers (e.g., insurance providers, HMOs) to which claims are submitted for remittance based on services provided to patients treated at the medical practice. Due to the large number of healthcare payers available to patients, the task of determining which payers are the most relevant to a particular practice's patient base is often a difficult task. To this end, some embodiments of the invention are directed to methods and apparatus for narrowing down the list of potential payers so that an administrator or other user at a medical practice is able to more easily determine the subset of payers to which the majority of the practice's claims will be sent. As a result, the medical practice may focus on enrolling, at least initially, with this subset of likely payers, while enrolling with other payers at a later time.

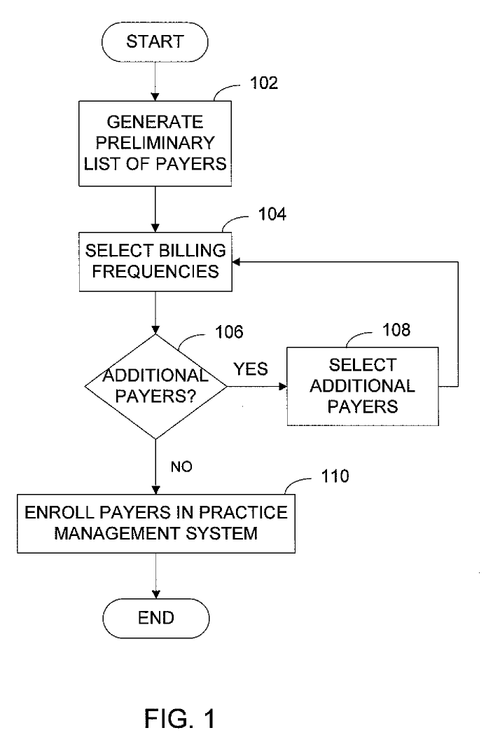

An exemplary illustration of a method for generating a list of likely payers is shown in FIG. 1. In act 102, a preliminary list of payers is generated for a medical practice based on a characteristic of the medical practice such as its geographic location, and historical data about payer activity within the geographic location. For example, if the medical practice is located in Boston, Mass., the preliminary list of payers may include payers that are most frequently used in Massachusetts, or some other geographic location in which Boston resides (e.g., the Northeastern United States).

In some embodiments, the preliminary list of payers is generated based on historical data collected by a practice management system over a predetermined amount of time. In one implementation, the practice management system provides billing management services for a plurality of medical practices in a geographical region such as the state of Massachusetts, in which claims for each of the medical practices are processed via the practice management system. Historical data reflecting claim volumes processed by each payer in a particular geographical region may be determined over a predetermined period of time (e.g., 90 days), and this information may be used to rank the payers in terms of their claim volume for the particular geographical region. For example, a payer frequency distribution for each geographical region may be calculated by counting the total number of claims submitted to each payer over all practices in the practice management system over the past 90 days, and this historical information may be used to generate a subset of likely payers for the medical practice in a particular geographical region. It should be appreciated that the total number of claims submitted is one exemplary factor for ranking the payers, and other factors such as the total number of claim remittances/denials received from payers, or other claim-based metrics may also be used.

As described above, a preliminary list of payers is generated based on the historical data, and the preliminary payer list is displayed to a user at a medical practice. In act 104, the user selects billing frequencies for the different payers listed in the preliminary payer list. A further discussion of how billing frequencies are categorized according to some embodiments of the invention is provided below.

In act 106, it is determined if there are additional payers (i.e., payers not on the preliminary payer list) that the user would like to add to the list of payers. If the user determines that additional payers should be added to the list, these additional payers are selected in act 108, and the corresponding billing frequencies for the additional payers are selected in act 104. The additional payers may be selected in any suitable way, and embodiments of the invention are not limited in this respect. For example, information about the additional payers may be entered manually by the user. Alternatively, one or more searching algorithms may be used to search for information stored on the practice management system based on a search term provided by the user. Additional details about adding additional payers which were not identified in the preliminary list of payers is provided below.

The process of adding additional payers continues until it is determined in act 106 that all of the payers for the medical practice have been identified. In some embodiments, the finalized payer list is stored on a storage device located at the medical practice and/or at one or more separate facilities associated with the practice management system. The payer list may be referenced within the practice management system at later points in time for various reasons, including, for example, predicting the percentage of claims that can be sent to a payer on a given day with reasonable confidence that the claims will not be denied or rejected because of incomplete practice enrollment.

After the payer list has been finalized, the payers in the list are enrolled for the medical practice in act 110. Enrollment of the payers in the list for the medical practice may be performed in any suitable way and embodiments of the invention are not limited in this respect. In one implementation, after the list of payers has been finalized, enrollment instructions for some or all of the payers on the list may be provided to the user at the medical practice, and the user may follow the enrollment instructions to complete enrollment (e.g., by contacting the individual payers). In another implementation, the enrollment process may be automated so that the necessary enrollment information about the payers in the list is automatically sent to the individual payers via the practice management system and the practice management system is updated to associate the medical practice with each payer in the list. In another implementation, the enrollment process may be semi-automatic or “guided” in that the user may be guided through the process of enrolling payers in the list via instructions and/or suggestions presented on a graphical user interface or other communication medium. In this implementation, the user may retain a greater degree of control over the enrollment process than if the enrollment process was fully automated.

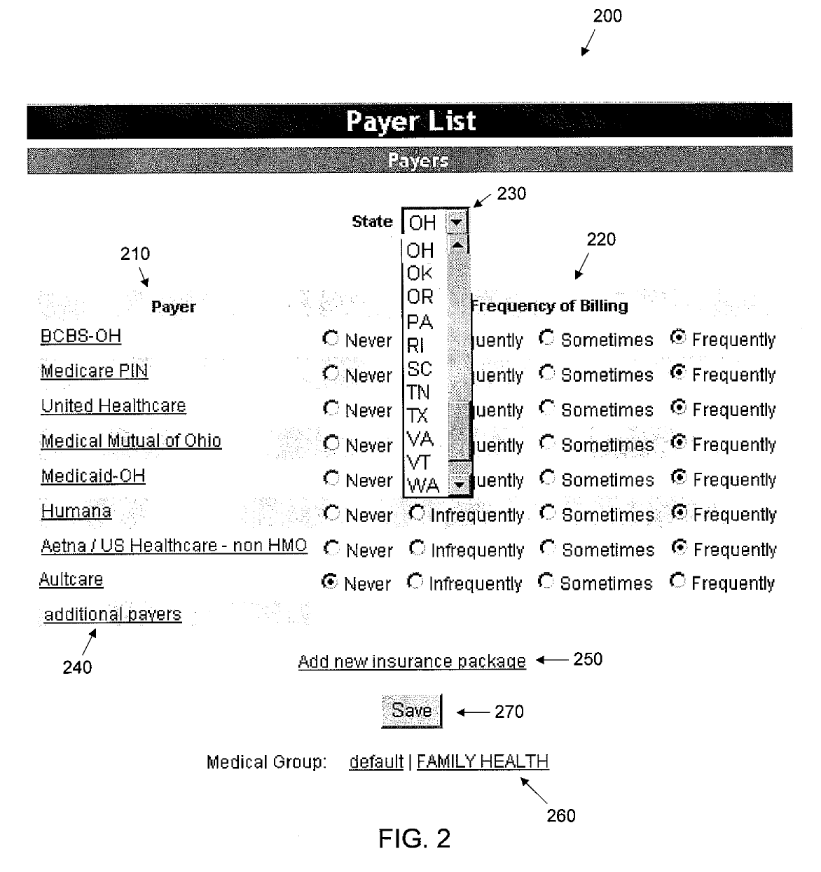

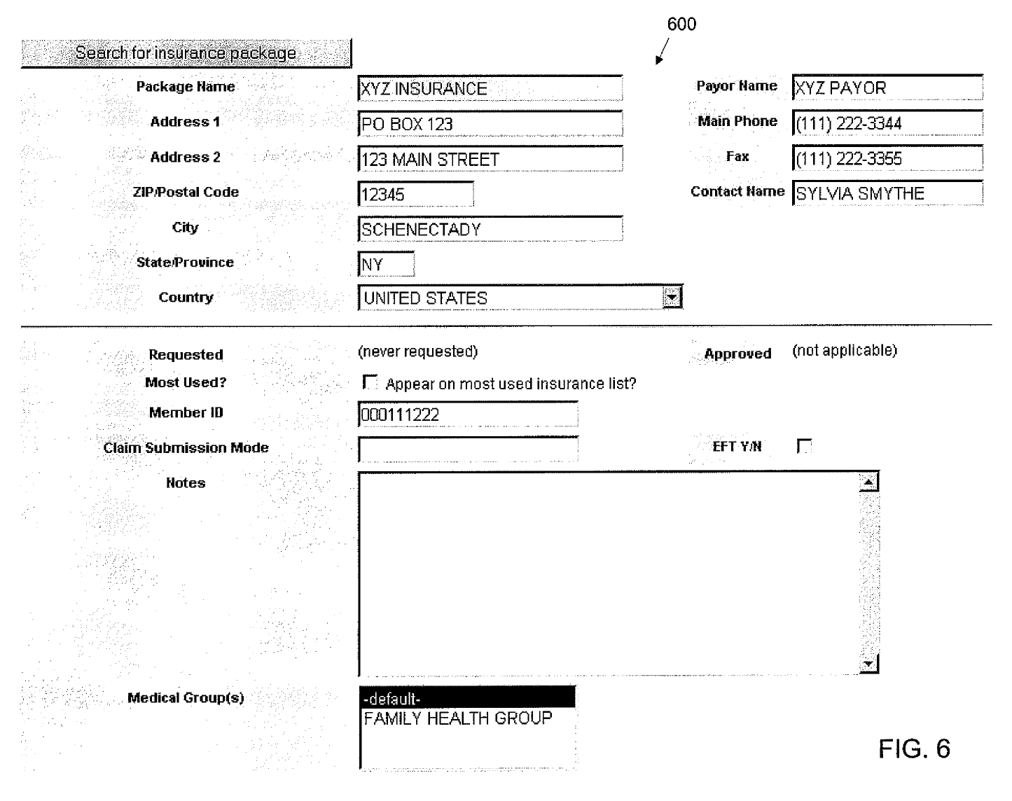

Payer identification methods and apparatus in accordance with embodiments of the invention may be implemented in hardware, software, or some combination thereof, and embodiments are not limited in this respect. Exemplary illustrations of an embodiment of the invention implemented in software as a portion of a program configured to be executed on at least one computer are shown in FIGS. 2-6.

FIG. 2 illustrates a preliminary payer list 200 that is generated by some embodiments of the invention and may be displayed to a user at a medical practice. The preliminary payer list 200 comprises a plurality of payer identifiers 210, and a billing frequency indicator 220 associated with each of the plurality of payer identifiers 210. In some embodiments, the payer identifiers 210 identify payers in a geographical region that have the highest claim volume for that geographical region. Such a representation may facilitate a medical practice's enrollment with payers that are routinely used by patients within the geographical area in which the medical practice treats patients.

In some embodiments, a default billing frequency may be specified for each payer identifier 210 based on historical data, as described above, although in other embodiments, a default billing frequency may not be specified. Although shown as a series of radio buttons in FIG. 2, the billing frequency indicator 220 may alternatively comprise any suitable indicator for specifying a billing frequency including, but not limited to, checkboxes, sliders, text boxes, or other toggle buttons with which a user may interact to select a billing frequency. Additionally, any suitable scale may be used to determine and/or interpret the values of the billing frequency indicator 220. An exemplary billing frequency indicator scale is illustrated in Table 1.

TABLE 1
Exemplary frequency-usage criteria

| Frequency | Usage |
|---|---|
| Never | Less than once a year |
| Infrequently | More than once a year, less than every month |
| Sometimes | More than once a month, less than every week |
| Frequently | At least once a week |

Although the frequency-usage criteria of Table 1 demonstrates a scale with four levels of granularity, it should be appreciated that a scale with any suitable cutoff criteria and any level of granularity may alternatively be used.

Some medical practices may treat patients in more than one geographical region. Accordingly, preliminary payer list 200 may also comprise a geographical region indicator 230 which comprises a list of geographical regions that a user may select. In the illustrative example of FIG. 2, the geographical region indicator 230 lists states which may be selected by a user. However, it should be appreciated that other geographical regions, such as cities, counties, countries, regions of a state or country, etc., may alternatively be used. In some embodiments, when a user interacts with the geographical region indicator 230 to select a different geographical region, the list of payer identifiers 210 and associated billing frequency indicator 220 may be updated to reflect the payers with the largest claim volumes for the selected geographical region.

Preliminary payer list 200 additionally comprises an additional payers selector 240 with which a user may interact to add additional payers not listed in the preliminary payer list 200. For example, a medical practice may have knowledge that a payer with a relatively low claim volume is used by patients treated at the medical practice, and the user may want to add this payer to the payer list. To add this payer, the user may interact with additional payers selector 240 to manually enter information about the payer, or search for this additional payer within the practice management system, as is described in greater detail below.

Some medical practices may desire to add payers to payer list that have not previously been used in the practice management system. Accordingly, preliminary payer list 200 may additionally comprise a new insurance package selector 250 with which a user may interact to manually enter new payers that do not have information stored within the practice management system. A process for manually entering payer information is described in more detail below.

Some medical practices may have multiple medical groups within the practice, and may wish to determine medical-group specific payer lists for each of the groups. For example, a practice may want to create a separate list for a “family health” group, and a “women's health” group. Accordingly, in some embodiments, preliminary payer list 200 additionally comprises a group selector 260 with which a user may interact to select a different medical group for the medical practice. In some embodiments, in response to selecting the group selector 260, a new medical group-specific payer list is created and the list is pre-populated with the same payers and billing frequencies that were selected for the preliminary payer list 200. After the new medical group-specific payer list is created, the user may then change the payers and billing frequencies as described in further detail below.

After a preliminary payer list 200 has been displayed to a user, the user may interact with the user interface to, for example, confirm or change a default billing frequency indicator 220 value for each payer to reflect the user's estimate of the medical practice's actual billing volume to the corresponding payer. A user may select different geographical regions by using the geographical region indicator 230 and may confirm or change billing frequency indicator 220 values for each of the geographical regions as so desired. Once the user has determined that no more changes are to be made, the user may interact with the save indicator 270 to store a copy of the preliminary payer list 200. As described above, one or more copies of the preliminary payer list 200 may be stored in any suitable location including, but not limited to, a local copy stored at the medical practice and a copy stored at one or more remote facilities associated with the practice management system. Although the user may store a copy of the preliminary payer list 200 when the user is finished reviewing or modifying the components of the payer list, in some embodiments, the user may also store a copy of the preliminary payer list 200 at any time by interacting with the save indicator 270.

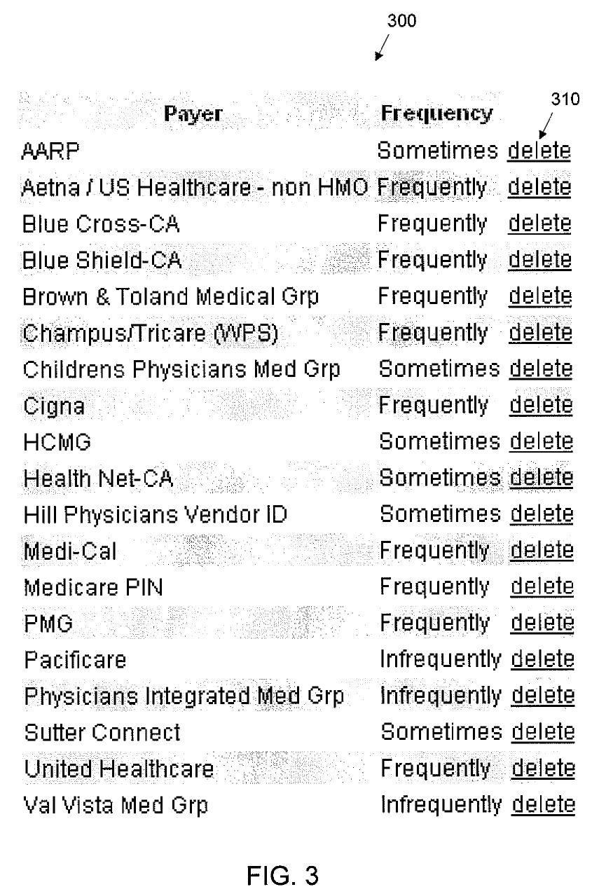

In some embodiments, a summary of the preliminary payer list 200 is provided as payer list 300 as shown in FIG. 3. Payer list 300 comprises only payers that the medical practice has indicated that they bill to. In some embodiments, payer list 300 does not include all of the payers listed in preliminary payer list 200, as payers with a billing frequency of “Never” are not included in payer list 300. Accordingly, a user may review payer list 300 to determine if any of the payers was incorrectly included on the list and should be removed. A user may remove a payer from payer list 300 by interacting with delete indicator 310 located adjacent to the payer identifier for the payer to be deleted. For example, if a user wanted to remove the payer “AARP,” the user would select the delete indicator 310 in the same row as the payer identifier AARP. In doing so, the payer “AARP” would be removed from the payer list 300. An exemplary method of removing the payer from the list is to set the removed payer's billing frequency indicator value to “Never,” which removes the payer from payer list 300, but retains the payer in preliminary payer list 200. Alternatively, the payer may be removed from both lists, and embodiments of the invention are not limited in this respect.

In some embodiments of the invention, a percentage of a medical practice's total claim volume may be calculated for each payer in payer list 300 based at least in part on historical data stored on the practice management system. For example, based on the historical data, each of the payers in payer list 300 may be assigned a weight that is equal to the number of claims billed in the geographical region where the medical practice is located, and each payer's weight may be multiplied by a scaling factor based on the billing frequency that has been assigned to each payer by the medical practice. In one exemplary implementation in which billing frequency is categorized into four levels of granularity as shown in Table 1 above, the multiplier may be 1 for payers assigned a billing frequency of “Frequently,” 0.7 for payers assigned a billing frequency of “Sometimes,” and 0.2 for payers assigned a billing frequency of “Infrequently.” Using these criteria, or any other suitable criteria, the number of claims that the medical practice is expected to bill to each payer may then be calculated as being proportional to each payer's multiplied weight.

In one implementation, expected claim volumes for each payer as calculated above, or using other suitable calculation methods, may be adjusted to account for payer routing for healthcare payers that have claims billed in more than one geographical region. For example, the claim volume for a payer of an HMO in one geographical region may be augmented by adding claim volumes from payers of the same HMO in other geographical regions. Accordingly, the payer's claim volume calculated for the geographical region where a medical practice is located may be representative of the number of claims that the medical practice can expect to submit to the payer, regardless of the geographical region to which the claims are actually submitted.

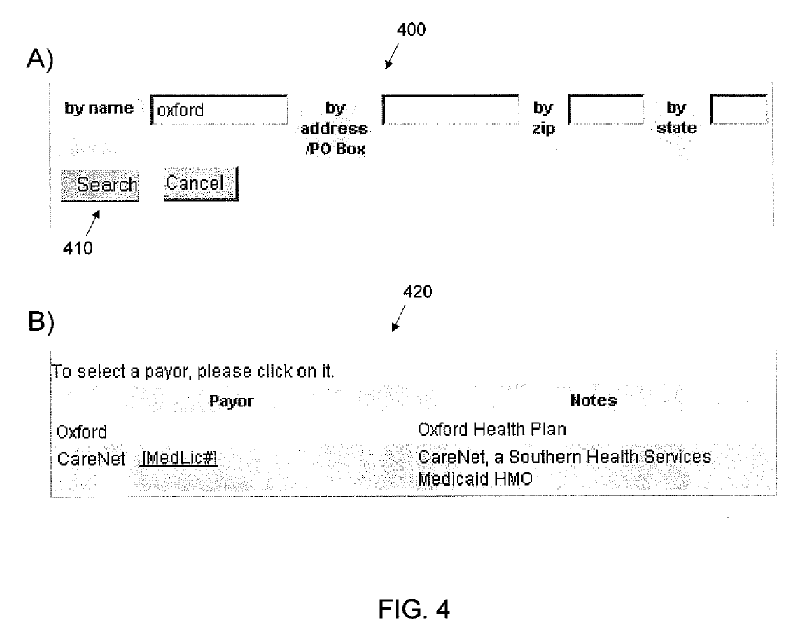

As described above, payers not included in the preliminary payer list 200 may be added by interacting with the additional payers selector 240. In some embodiments, interacting with the additional payers selector 240 enables the user to interact with add payers interface 400 illustrated in FIG. 4A. In the implementation shown in FIG. 4A, add payers interface 400 comprises a plurality of search fields within which the user may enter information to search payer information stored in the practice management system. For example, the user may enter name or address information for the desired payer to add to the payer list, and payer data stored on the practice management system is searched for the desired payer information when the user selects search indicator 410.

In response to interacting with search indicator 410, the practice management system is searched for the requested payer data based on the search criteria entered in add payers interface 400, and an additional payer list 420 comprising a list of payers matching the search criteria is displayed as shown in FIG. 4B. If the desired payer is included in the list of displayed payers, the user may select the desired payer from the list and the desired payer is added to the preliminary payer list 200. Once the desired payer is added to the preliminary payer list 200, the user may interact with the billing frequency indicator 220 to select a billing frequency value for the added payer. If the desired payer is not included in the list of displayed payers, the user may execute another search for the desired payer information, or the user may alternatively manually enter information about the desired payer, as described in further detail below.

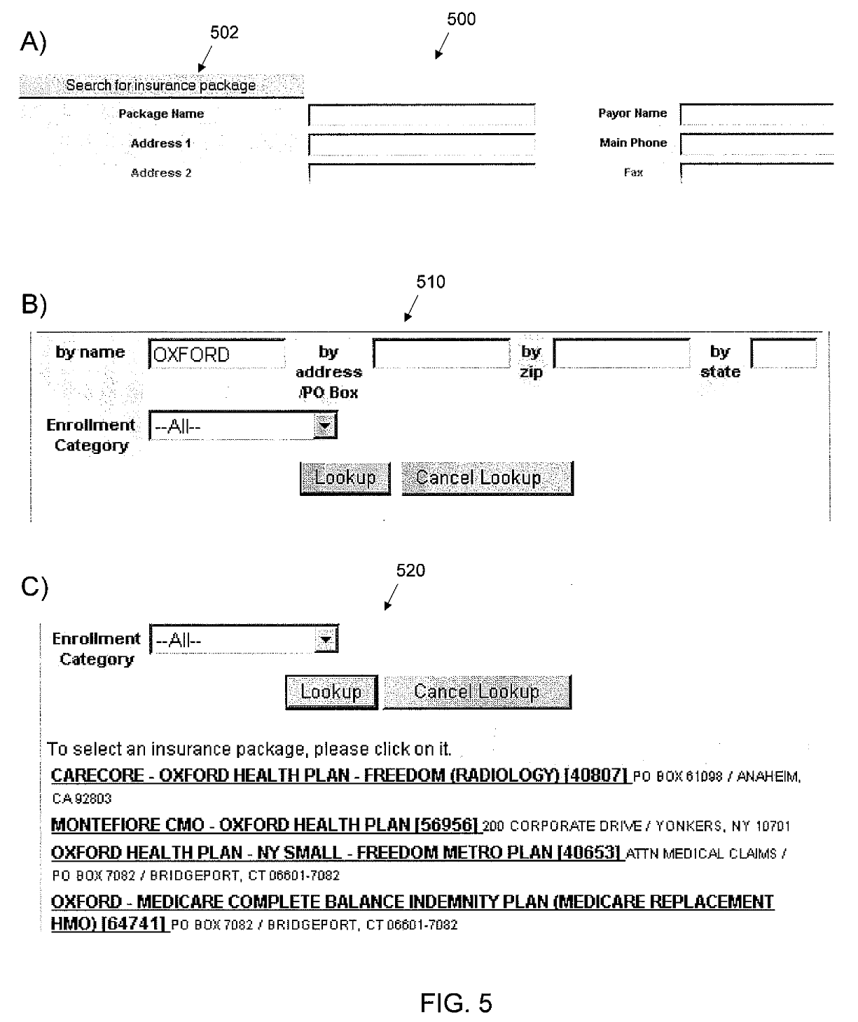

If a user desires to add a payer that is not found using the above search technique, the user may interact with an insurance package selector 250 to manually add information about the desired payer and/or insurance package. In response to selecting new insurance package selector 250, insurance package information interface 500 comprising a plurality of fields for entering data about the desired payer is displayed as shown in FIG. 5A. In the illustrative example of FIG. 5A, the user may enter a package name, payer name, or other information about the payer such as payer contact information. Then, the user may select search package indicator 502 to search the practice management system for information about a specific insurance package.

In response to interacting with search package indicator 502, search interface 510 may be displayed to the user, in which the user may enter information about a particular insurance package to be searched for as shown in FIG. 5B. Package attributes such as a package name, payer address, or enrollment category may be entered and used as search criteria. After the user has entered the search criteria, a search is conducted by searching the practice management system for information related to the desired insurance package. In response to executing the search, search output 520 comprising a list of insurance packages matching the search criteria as shown in FIG. 5C may be displayed to the user, and the user may select an insurance package from the list.

If the search output 520 does not include the desired insurance package/payer to add, information may be manually entered by the user into a preliminary insurance packages interface 600. After manually adding information into the preliminary insurances packages interface 600, the information about the payer is stored on the practice management system.

Applicants have recognized and appreciated that some medical practices may be concerned about cash flow reductions during the time when the medical practice is implemented on a practice management system. As described above, when a medical practice is implemented on a practice management system, the medical practice is typically enrolled with multiple healthcare payers, and each of these payers may process enrollment applications at a different rate. Because applications for enrollment of services at healthcare payers vary from payer to payer (and service to service), historical enrollment data stored on the practice management system may be used to predict the degree to which cash flow may be reduced for a medical practice given their current or projected status of enrollment for the payers on payer list 200.

Accordingly, in some embodiments, information in payer list 200 and historical data about healthcare payers, which is stored on the practice management system, is used to estimate a medical practice's uninterrupted cash flow at the date when the medical practice is implemented on the practice management system. This date may be referred to as the “go-live” date for the medical practice, as it is the date after which the medical practice begins using the management services provided by the practice management system. Information about the readiness of a medical practice to go-live with respect to possible temporary reductions in cash flow due to enrollment may facilitate decisions as to scheduling a particular go-live date.

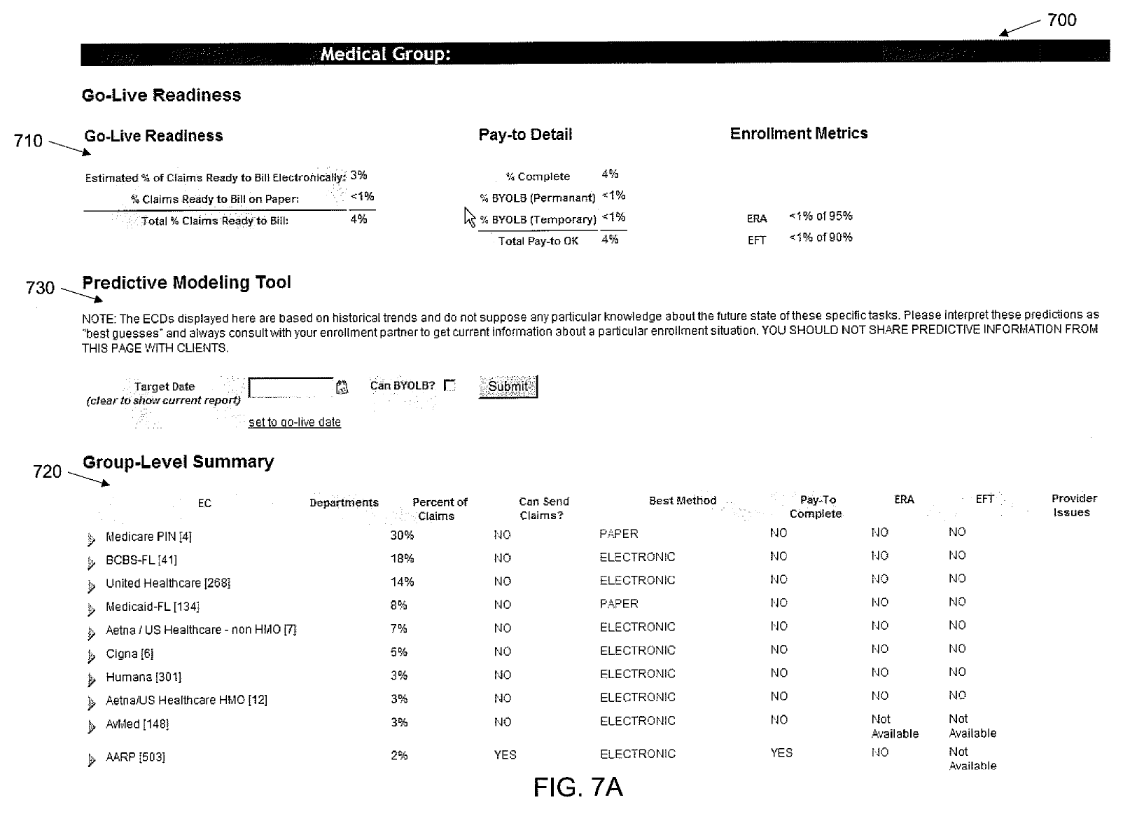

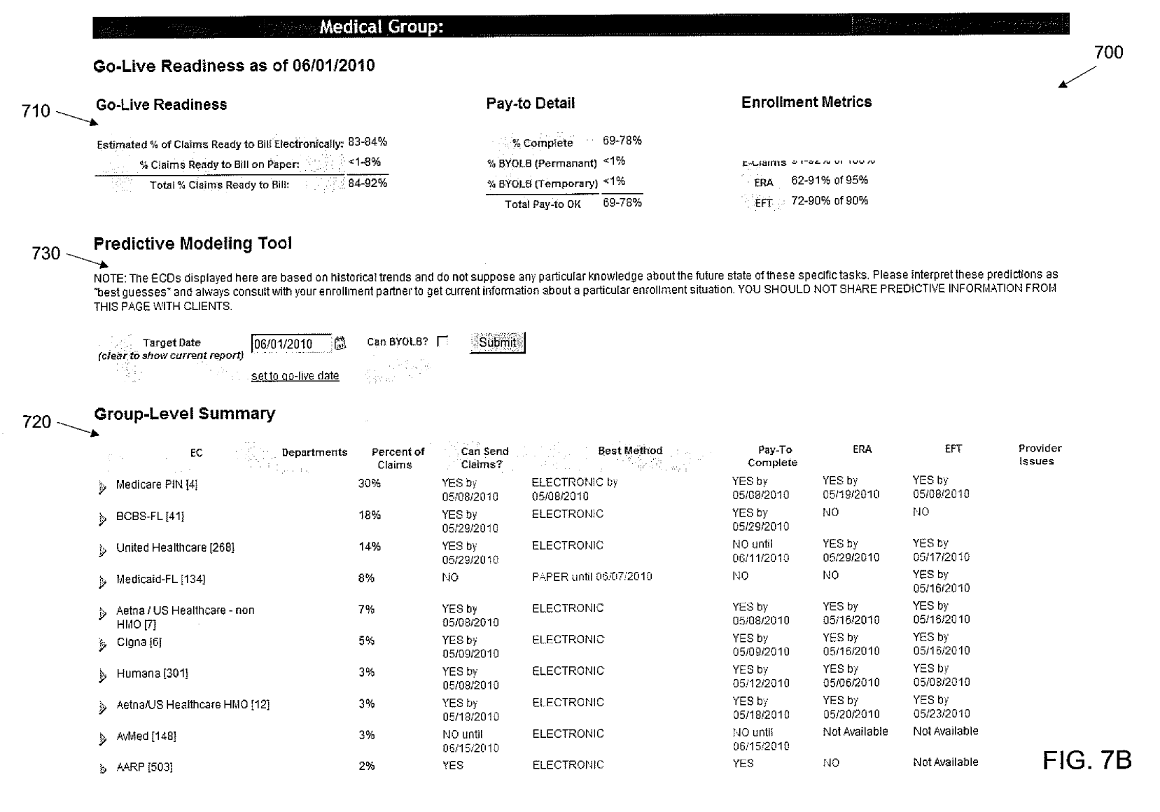

An example of an interface for displaying information about a medical practice's enrollment status in accordance with some embodiments is shown in FIG. 7A. Enrollment interface 700 displays an estimated percentage of claims that a medical practice may expect to be paid for based on their current enrollment status with payers listed in payer list 200. In some embodiments, one or more readiness scores for a medical practice may be calculated and displayed on enrollment interface 700 based on the enrollments that have been completed weighted by a percentage of the medical practice's claim volume that has been assigned to those payers by a user at the medical practice.

In one implementation, enrollment interface 700 comprises an overall summary section 710 for a medical practice and a group-level summary section 720 grouped by payer. The overall summary section 710 displays information about the overall enrollment status of the medical practice, or groups within the medical practice, with healthcare payers listed on payer list 200. For example, overall summary section 710 may include an estimate of the percentage of a medical practice's claims that may be submitted to payers for which enrollment has been completed so that the claims can be submitted to the payer. Overall summary section 710 may also include information related to the percentage of claims that have been enrolled for electronic billing, electronic remittance advices (ERA), electronic funds transfer (EFT), or other services for which the medical practice is enrolled with the payers on payer list 200.

Group-level summary section 720 may comprise enrollment information for one or more healthcare payers. For example, group-level summary section 720 comprises information about the payers such as an enrollment category (EC) and enrollment metrics represented as percentages of the total projected claim volume for a medical practice weighted by payer. In one implementation, each payer's contribution is a percentage that is based on the average claim volume in the geographical area where the medical practice is located and the value of the billing frequency indicators 220 in payer list 200. Group-level summary section 720 may also comprise one or more indications as to the status of enrollments for the healthcare payers, such as whether enrollment is complete and claims may be sent to the payer. Furthermore, in some embodiments, group-level summary section 720 may indicate the departments at the medical practice to which the enrollment information pertains. Although enrollment interface 700 has been shown to have particular fields for displaying data configured in a particular manner, it should be appreciated that any suitable configuration and/or type of enrollment interface may be used and embodiments are not limited in this respect.

In some embodiments, enrollment interface 700 may include a predictive modeling component 730 with which a user may interact to determine one or more enrollment scenarios. For example, a user may input a future go-live date, and the enrollment scores displayed in the overall summary section 710 and the group-level summary section 720 of enrollment interface 700 may be estimated based on historical data stored on the practice management system that relates to prior enrollment performance of at least some of the payers on the payer list 200 for the medical practice.

In one implementation, the historical data comprises status information for enrollment applications that are tracked throughout their lifecycle for numerous payers in the practice management system. From the historical data, the length of time for enrollment applications to be processed by individual payers for particular types of enrollment applications may be determined, and this information is used to predict the values displayed on enrollment interface 700 using the go-live date provided by the user at the medical practice. A user interface including predictive modeling component 730 may be used to intelligently schedule or reschedule a go-live date based on one or more enrollment scenarios calculated using different go-live dates.

FIG. 7B illustrates another example of an interface for displaying information about a medical practice's enrollment status in accordance with some embodiments. As described above with reference to FIG. 7A, enrollment interface 700 includes overall summary section 710, group-level summary section 720, and predictive modeling component 730. As is evidenced by FIG. 7B, a user may enter a target go-live date (e.g., 6/1/10) into predictive modeling component 730 in order to estimate an expected percentage of payers that are expected to be enrolled as of the entered target go-live date. For example, although FIG. 7A shows that only 4% of claims would be ready to process on a particular date before the target go-live date (e.g., 5/7/10), by entering the target go-live date into predictive modeling component 730, the anticipated “readiness” of the medical practice on the target go-live date may be estimated. As shown in FIG. 7B, the predictive modeling component has estimated that 84%-92% of claims should be ready to be processed by the target go-live date, and enrollment is proceeding well.

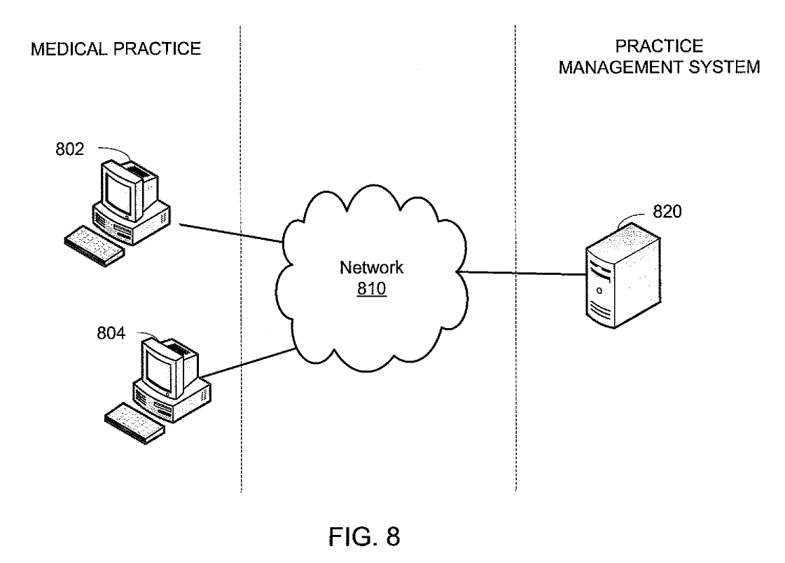

FIG. 8 illustrates an exemplary networked system on which some embodiments of the invention may be employed. Networked computers 802 and 804 located at a medical practice and computer 820 located at a location associated with a practice management system are shown connected to a network 810. Network 810 may be any type of local or remote network including, for example, a local area network (LAN) or a wide area network (WAN) such as the Internet. In the example of FIG. 8, three networked computers are shown. However, it should be appreciated that network 810 may interconnect any number of computers of various types and the networked system of FIG. 8 is provided merely for illustrative purposes. For example, computer 820 may be connected via network 810 (or other networks) to a plurality of computers at a plurality of medical practice locations to provide practice management services to each of the connected medical practices. As should be appreciated from the foregoing, embodiments of the invention may be employed in a networked computer system regardless of the type or network size or configuration.

Having thus described several aspects of some embodiments of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a non-transitory tangible computer-readable storage medium (or multiple computer-readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer-readable storage medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” shall have its ordinary meaning as used in the field of patent law.

As used herein in, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method of identifying a subset of payers for a medical practice, the method comprising:
selecting, with at least one processor, the subset of payers from a plurality of payers based, at least in part, on historical data, wherein the historical data comprises claim volume information for the plurality of payers within a geographical location; and
displaying the selected subset of payers to a user.

2. The method of claim 1, wherein the claim volume information is collected over a predetermined period of time, wherein the method further comprises:
ranking the plurality of payers based, at least in part, on the claim volume information; and
wherein selecting the subset of payers comprises selecting based, at least in part, on the ranking of the plurality of payers.

3. The method of claim 2, wherein the claim volume information comprises a total number of claims submitted to at least some of the plurality of payers during the predetermined period of time.

4. The method of claim 2, wherein the claim volume information comprises a total number of claim remittances and/or claim denials received from the plurality of payers during the predetermined period of time.

5. The method of claim 1, further comprising:
associating a billing frequency for each of the payers in the subset of payers.

6. The method of claim 5, further comprising:
generating a payer list based, at least in part, on the billing frequency associated with each of the payers in the subset of payers.

7. The method of claim 6, further comprising:
excluding from the payer list, payers associated with a billing frequency below a threshold value.

8. The method of claim 6, further comprising:
calculating based, at least in part, on the billing frequencies, an expected claim volume for at least one of the payers in the payer list.

9. The method of claim 8, wherein the expected claim volume is calculated based, at least in part on payer routing information.

10. The method of claim 6, further comprising:
adding at least one additional payer to the payer list based on an input received from the user.

11. The method of claim 1, further comprising:
estimating based, at least in part on the historical data for payers in the selected subset of payers, an uninterrupted cash flow for the medical practice.

12. The method of claim 11, further comprising:
determining a readiness for the medical practice to be implemented on a practice management system based, at least in part on the estimated uninterrupted cash flow.

13. A computer-readable storage medium, encoded with a plurality of instructions, that when executed by a computer, perform a method comprising:
selecting a subset of payers from a plurality of payers based, at least in part, on historical data, wherein the historical data comprises claim volume information for the plurality of payers within a geographical location; and
displaying the selected subset of payers to a user.

14. The computer-readable storage medium of claim 13, wherein the claim volume information is collected over a predetermined period of time, wherein the method further comprises:
ranking the plurality of payers based, at least in part, on the claim volume information; and
wherein selecting the subset of payers comprises selecting based, at least in part, on the ranking of the plurality of payers.

15. The computer-readable storage medium of claim 13, wherein the method further comprises:
associating a billing frequency for each of the payers in the subset of payers; and
generating a payer list based, at least in part, on the billing frequency associated with each of the payers in the subset of payers.

16. The computer-readable storage medium of claim 15, wherein the method further comprises:
calculating based, at least in part, on the billing frequencies, an expected claim volume for at least one of the payers in the payer list.

17. A computer system comprising at least one client computer and at least one host computer coupled to the at least one host computer, the at least one host computer having at least one program stored thereon, that when executed, performs a method comprising:
selecting a subset of payers from a plurality of payers based, at least in part, on historical data, wherein the historical data comprises claim volume information for the plurality of payers within a geographical location; and
sending the selected subset of payers to a user to the at least one client computer for display to a user.

18. The computer system of claim 17, wherein at least one host computer implements a practice management system that stores at least some of the historical data.

19. The computer system of claim 17, wherein the at least one client computer is configured to display an interactive user interface to enable the user to select payers with which the medical practice would like to enroll.

20. The computer system of claim 17, wherein the claim volume information is collected over a predetermined period of time, wherein the method further comprises:
ranking the plurality of payers based, at least in part, on the claim volume information; and
wherein selecting the subset of payers comprises selecting based, at least in part, on the ranking of the plurality of payers.
